(19) United States
(12) Patent Application Publication
(10) Pub. No.: US 2002/0041142 A1
(43) Pub. Date: Apr. 11, 2002

(54) Cathode supporter for electric gun in CRT

(75) Inventors: Gill Young Jung, Kyongsangbuk-do (KR); Ki Bog Son, Kyongsangbuk-do (KR)

Correspondence Address: FLESHNER & KIM, LLP, P.O. Box 221200, Chantilly, VA, 20153-1200, US

(73) Assignee: LG Electronics Inc.

(21) Appl. No.: 09/899,934

(22) Filed: Jul. 9, 2001

(30) Foreign Application Priority Data
Oct. 10, 2000 (KR) 2000-59474

(51) Int. Cl. H01K 1/00; H01J 1/00; H01J 19/00; H01J 1/53; H01J 1/88; H01J 19/42; H01J 29/46

(52) U.S. Cl. 313/451; 313/238; 313/241; 313/251; 313/252

(57) ABSTRACT

Disclosed is a cathode supporter for an electric gun in a CRT(Cathode Ray Tube), which can reduce an amount of expensive ceramics glass used, which is filled within the cathode supporter, by removing guide pipes from the cathode supporter, which is conventionally provide with the guide pipes through which guide pins of a beading jig are inserted, to decrease a horizontal length a of the cathode supporter. According to a preferred embodiment of the present invention, the electric gun includes three cathodes for radiating electron beams, a plurality of electrodes for controlling, accelerating and focusing the electron beams, and guide holes formed at both sides of some electrodes among the plurality of electrodes for allowing guide means to be inserted therethrough, wherein the horizontal length of the cathode supporter for supporting the cathodes are smaller than an inside horizontal length of the guide means to prevent any interference from being generated between the cathode supporter and the guide pins. Here, the inside horizontal length of the guide pins corresponds to an inside width W₂ between the respective guide holes.

### BACKGROUND OF THE INVENTION

1. Field of the Invention

The present invention generally relates to a cathode supporter for an electric gun in a CRT(Cathode Ray Tube), and more particularly to a cathode supporter for an electric gun in a CRT, which can reduce an amount of expensive ceramics glass filled in the CRT by removing guide pipes from a cathode supporter, which is conventionally provided with pipe guides into which guide pins of a beading jig are inserted, to reduce a horizontal length of the cathode supporter.

2. Description of the Related Art

FIG. 1 is a partial, vertical cross-sectional view showing a schematic configuration of an electric gun embedded in a general color CRT(Cathode Ray Tube). Referring to FIG. 1, the electric gun is roughly divided into two parts, namely, a triple-electrode part 10 and a main lens part 20.

The triple-electrode part 20 is comprised of a cathode 11 for radiating an electron beam, a control electrode 12 for controlling an amount of electron beam radiated, and a first accelerating electrode 13.

The main lens part 20 is comprised of first, second and three focusing electrodes, 21, 22 and 23 for finally focusing and accelerating the electron beam, and an anode electrode 24. A shield cup 25 is adhered to both ends of the anode electrode 24 to shield a leakage magnetic field. Contact springs 25 are installed on an end of the shield cup 25 and supported in an inner surface of a funnel (not shown) coated with graphite. Since the graphite receives a positive voltage, the anode electrode 24 receives the positive voltage through the contact springs 26.

In the meantime, a pre-focusing electrode 30 and a second accelerating electrode 40 are sequentially arranged between the triple-electrode part 10 and the main lens part 20 to permit a pre-focusing and a second acceleration of the electron beam.

A predetermined voltage is applied to the above electrodes. In detail, the control electrode 12 is grounded, a low voltage of 500 W to 1000 W is applied to the first and second accelerating electrodes 13 and 40, a high voltage of 25 Kv to 35 Kv is applied to the anode electrode 24, and an intermediate voltage corresponding to 20% to 30% of the anode electrode 24 is applied to the pre-focusing electrode 30 and the first, second and third focusing electrodes 21, 22 and 23.

Meantime, a neck part (not drawn) within which the electric gun is housed is provided in a rearward direction of the funnel. Since an inner wall of the neck part is not coated with graphite, graphite is not applied to the neck part in a direct manner. However, since graphite is coated up to a vicinity of a front end portion of the neck part where the shield cup 25 is positioned, a high organic voltage is charged along the inner wall of the neck part. Since there exists a difference between the organic voltage and the voltage applied to the each electrode of the electric gun, it would increase a possibility that an electric discharge arises between the inner wall of the neck part and the each electrode of the electric gun. Therefore, the respective electrodes of the electric gun are needed to be distanced from the inner wall of the neck part far enough to prevent the electric discharge. In more detail, since such intermediate and high voltage parts as the first, second and third focusing electrodes, the anode electrode 24, and the pre-focusing electrode 30 do not differ so much from the neck part in view of their voltage, the focusing electrodes 21, 22, and 23, the anode electrode 24 and the pre-focusing electrode 30 are preferably spaced from the inner wall of the neck part as far as 1.0 mm or so. Since the low voltage parts including the cathode supporter 14 supporting the cathode 11, the control electrode 12, and the first and second accelerating electrodes 13 and 40 differ so much from the neck part in view of their voltage, the cathode supporter 14 and the just aforementioned electrodes 12, 13 and 40 are preferably spaced from the neck part as far as approximately 1.5 mm.

Accordingly, if the electric gun is installed on a neck part of 29.1 mm in diameter and 2 mm in thickness, except the case that the neck part is 2 mm in thickness and the electric gun is distanced from the inner wall of the neck part as far as 1.5 mm, it is permissible that a horizontal length a of the cathode supporter 14, and a horizontal length W₁ of the control electrode 12, the accelerating electrode 13 and the pre-focusing electrode 30, respectively, are permitted up to approximately 75% of a diameter of the neck part.

Meanwhile, as shown in FIG. 2a and FIG. 2b, the cathode supporter 14 and the respective electrodes 12, 13, 21, 22, 23, 24, 30, and 40 are aligned in series by a beading jig (not shown) for an automated assembling of the electric gun, and then are fixed to a bead glass 70 through a beading process. In more detail, guide pins 62 and guides 63 extend from an arm part 60 of the beading jig, wherein the guide pins 62 are inserted into guide holes 51, 52, 53, and 54 formed at both sides of the cathode supporter 14, the control electrode 12, the first accelerating electrode 13 and the pre-focusing electrode 30, while the guides 63 are inserted into cathode support tubes 141 of the cathode supporter 14. Further, mandrels 61 extending from the beading jig (not shown) are inserted into electron beam through holes of the pre-focusing electrode 30, the second accelerating electrode 40, the first, second and third focusing electrodes 21, 22 and 23, and the anode electrode 24. Therefore, the cathode supporter 14 and the electrodes 12, 13, 21, 22, 23, 24, 30, and 40 of the low, intermediate, and high voltage parts are aligned along an axial line of the mandrels 61 and the guide pins 62.

On both side parts of the horizontal length (W₁) of 22.1 mm of the aforementioned cathode supporter 14, the control electrode 12, the accelerating electrode 13 and the pre-focusing electrode 30, guide holes 51, 52, 53 and 54 are formed so as for the beading jig to be inserted therethrough to perform the automated assembling of the electric gun. On the other hand, since the beading jig is not used for a manual assembling, the guide holes 51, 52, 53 and 54 are not needed to be provided, whereby the horizontal length a of the cathode supporter and the horizontal length W₁ of the control electrode 12, the accelerating electrode 13 and the pre-focusing electrode 30 are designed to be 69% of the diameter of the neck part, approximately 20.0 mm.

Referring to FIG. 2a, the cathode supporter 14 comprises the three cathode support tubes 141 of metallic material for supporting the cathode 11, guide pipes 142 positioned at both sides of the cathode support tubes 141, respectively, a hermetic cap 143 for enclosing the cathode support tubes 141 and the guide pipes 142, and a ceramics glass 144 filled between the cathode support tubes 141 and the guide pipes 142 for fixing the cathode support tubes 141 and the guide pipes 142. Here, a hollow part of the guide pipes 142 functions as the guide holes 51 through which the guide pins 62 of the beading jig are inserted. A dimension of the hermetic cap 143 is expressed by a ratio a/b of a horizontal length of the hermetic cap 143 to a height b of the hermetic cap 143. The hermetic cap 143 is 20.0 to 22.1 mm in horizontal length as likely as the horizontal length a of the cathode supporter and 0.6 mm in height. Accordingly, the ratio a/b of the horizontal length a to the height b of the hermetic cap 143 ranges from 2.08 to 2.30.

The cathode supporter 14 is completed through the following manufacturing processes. First, the ceramics glass 144 is inserted into the hermetic cap 143 and then the cathode support tubes 141 and the guide pipes 142 are inserted into the holes 55 formed on the ceramics glass 144. The assembled cathode supporter 14 is thermally heated to fuse the low melting point ceramics glass 144. Next, the ceramics glass 144 is such solidified and shrunken that the respective members of the cathode supporter 14 are coupled to one another. Here, in an attempt to enhance a degree of coupling between the respective members 141, 142, 143, and 144 of the cathode supporter 14, a coefficient of thermal expansion of the respective members 141, 142, 143 and 144 of the cathode supporter 14 is set in an order of the following: the hermetic cap>the ceramics glass>the cathode support tubes=the guide pipes.

The cathode supporter 14 on which the guide pipes 62 are installed for the automation process gives rise to the following problems.

First, in the ceramics glass 144 fusing and fastening process, as illustrated in FIG. 3a, an easy adjustment is achieved in respect to a pitch P′ between central axes of the cathode support tubes 141, a pitch P between central axes of the control electrode 12 and the first accelerating electrode 13 and a pitch S between central axes of the guide holes 52, 53 and 54 of the control electrode 12, the accelerating electrode 13 and the pre-focusing electrode 30. However, an easy adjustment of the pitch S between the central axes of the guide holes 51 provided by the guide pipes 142 fixed during the ceramics glass 144 fastening process is not achieved. Thus, it is not easy to adjust an interval C between peripheral lines of the cathode support tubes 141 and the guide pipes 142, which are formed on the cathode supporter 14 as shown in FIG. 2b, in accordance with a design. In consequence, the pitch S of the guide holes 51 of the cathode supporter 14 fails to be aligned with the pitch S of the guide holes 52, 53, and 54 of the control electrode 12, the first accelerating electrode 13 and the pre-focusing electrode on a coaxial line. If the electric gun is completed in this condition, as drawn in FIG. 3b, it will end in a misalignment of the pitch P′ between the central axes of the cathode support tubes 141 with the pitch P between the central axes of the electron beam through holes of the control electrode 12 and the first accelerating electrode 13. Accordingly, as depicted in FIG. 3b, the cathode 11 and the control electrode 12 can not maintain a constant interval G therebetween, and the cathode 11 and the control electrode 12 are forced to have an interval G′, which becomes larger at a left side and at the same time becomes smaller at right side. This interval may become vice versa depending on a deformation position of the guide pipes 62. In the state where the pitch P′ of the cathode support tubes 141 is not in alignment with the pitch P of the control electrode 12 and the first accelerating electrode 13, and the interval between the cathode 11 and the control electrode 12 becomes wider or narrower, a route of the electron beam may be changed when the electric gun is operated, thereby resulting in picture degradation.

Second, in the cathode supporter 14, the hermetic cap 143, the ceramics glass 144 and the cathode support tubes 141 are essential components in an operation of the cathode ray tube. However, the guide pipes 142 are solely needed in the automated assembling of the electric gun and do not play any role in the operation of the electric gun. The guide pipes 142 deteriorate performance characteristic of the electric gun, instead, by generating leakage currents between the guide pipes 142 and the cathode support tubes 141 during the electric gun operation.

Third, the guide pipes 142 to the number of 2 are installed at both sides of the cathode supporter 14 for insertion of the guide pins 62. The cathode supporter 14 is accordingly increased in its horizontal length a as widely as an area occupied by the guide pipes 142, and requires more the expensive ceramics glass 144, thereby raising a manufacturing cost of the electric gun.

Meantime, since the guide pipes 142 used for forming the guide holes are not needed in the manual assembling, the cathode supporter 14 may reduce its horizontal length a as much as a width B of bridges 81, 82, and 83 and a diameter of the guide pipes 62. However, the horizontal length a of the cathode supporter 14 is conventionally limited to a value, 69% of the diameter of the neck part during the electric gun manufacture, leading to a waste of the expensive ceramics glass 144.

### SUMMARY OF THE INVENTION

It is, therefore, an object of the present invention to provide a cathode supporter for an electric gun in a CRT(Cathode Ray Tube), which can facilitate a process of assembling a cathode supporter and reduce an error in the cathode supporter assembling process.

It is another object of the present invention is to provide a cathode supporter for an electric gun in a CRT, which can prevent a leakage current from being generated between guide pipes and cathode support tubes.

It is further anther object of the present invention is to provide a cathode supporter for an electric gun in a CRT, which can facilitate a process of assembling a cathode supporter and reduce a manufacturing cost of an electric gun.

To achieve the above objects, there is provided a cathode supporter for an electric gun in a CRT according to a preferred embodiment, the electric gun including three cathodes for radiating electron beams, a plurality of electrodes for controlling, accelerating and focusing the electron beams, and guide holes formed at both sides of some electrodes among the plurality of electrodes for allowing guide means to be inserted therethrough, wherein a horizontal length of the cathode supporter supporting the cathodes is smaller than a horizontal length of an inside of the guide means to prevent any interference from being generated between the cathode supporter and the guide means.

To achieve the above objects, there is provided a cathode supporter for an electric gun in a CRT according to another preferred embodiment of the present invention, the electric gun including three cathodes for radiating an electron beam, and a plurality of electrodes for controlling, accelerating and focusing the electron beam, wherein a horizontal length of the cathode supporter supporting the cathodes is smaller than a horizontal length of a control electrode, an accelerating electrode, and a pre-focusing electrode among the plurality of cathodes.

### BRIEF DESCRIPTION OF THE DRAWINGS

Further objects and advantages of the invention can be more fully understood from the following detailed description taken in conjunction with the accompanying drawings, in which:

FIG. 1 is a partial, vertical cross-sectional view showing a schematic configuration of an electric gun for a conventional color cathode ray tube(CRT);

FIG. 2a is an exemplary view showing a state where guide pins of a beading jig are inserted through guide holes on a triple-electrode part and a pre-focusing electrode in the conventional electric gun;

FIG. 2b is a front view showing each electrode at the triple-electrode part of FIG. 2a;

FIG. 3a is a horizontal cross-sectional view of the triple-electrode part of the conventional electric gun, showing a state where a pitch P′ between central axes of cathode support tubes is aligned with a pitch P between central axes of a control electrode and a first accelerating electrode;

FIG. 3b is a horizontal cross-sectional view of the triple-electrode part of the conventional electric gun, showing a state where a pitch P′ between central axes of cathode support tubes is misaligned with a pitch P between central axes of a control electrode and a first accelerating electrode;

FIG. 4a is an exemplary view showing a state where guide pins of a beading jig are inserted through guide holes of a control electrode, a first accelerating electrode and a pre-focusing electrode according to the present invention;

FIG. 4b is a front view of each electrode at the triple-electrode part of the electric gun of FIG. 4a;

FIG. 5 is an exemplary view showing a state a cut part is formed at a rim part of a cathode supporter of the electric gun according to the present invention; and

FIG. 6 is a front view of the control electrode and the first accelerating electrode of FIG. 4b, showing a state where excess semicircles slightly larger than semicircles of the guide holes are formed at the control electrode and the first accelerating electrode.

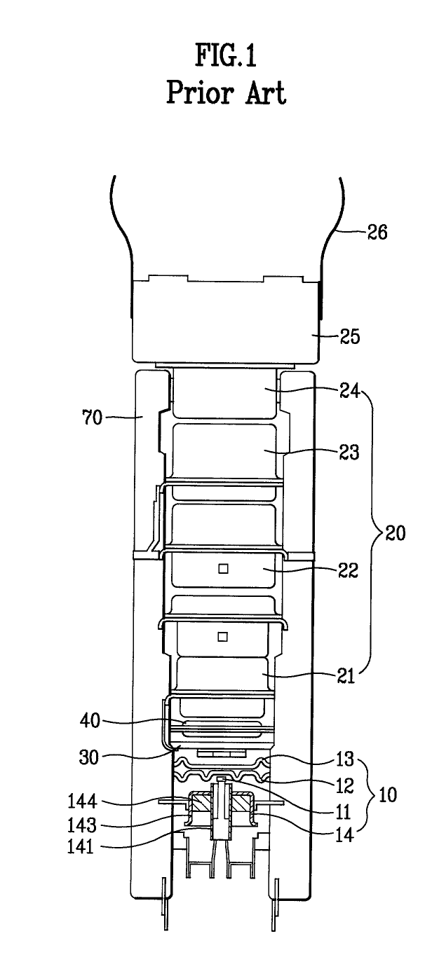

### DETAILED DESCRIPTION OF THE PREFERRED EMBODIMENT

The present invention will now be described in connection with preferred embodiments with reference to the accompanying drawings, in the several figures of which like reference numerals identify like elements.

The present invention is roughly divided into a preferred embodiment applied to an automated assembling of an electric gun and another preferred embodiment applied to a manual assembling of an electric gun.

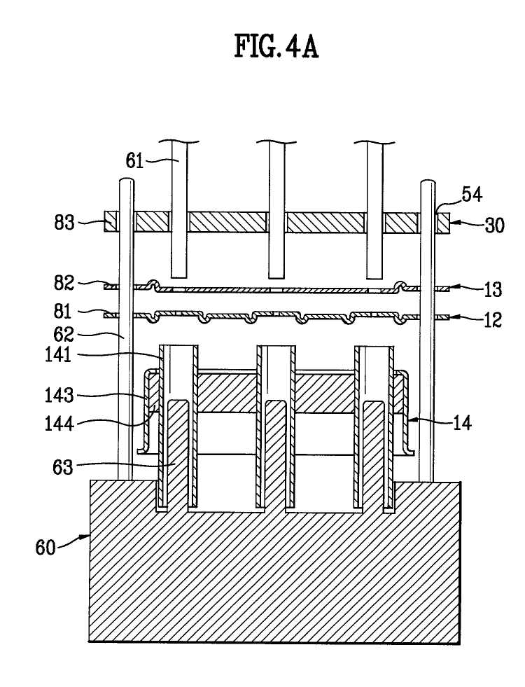

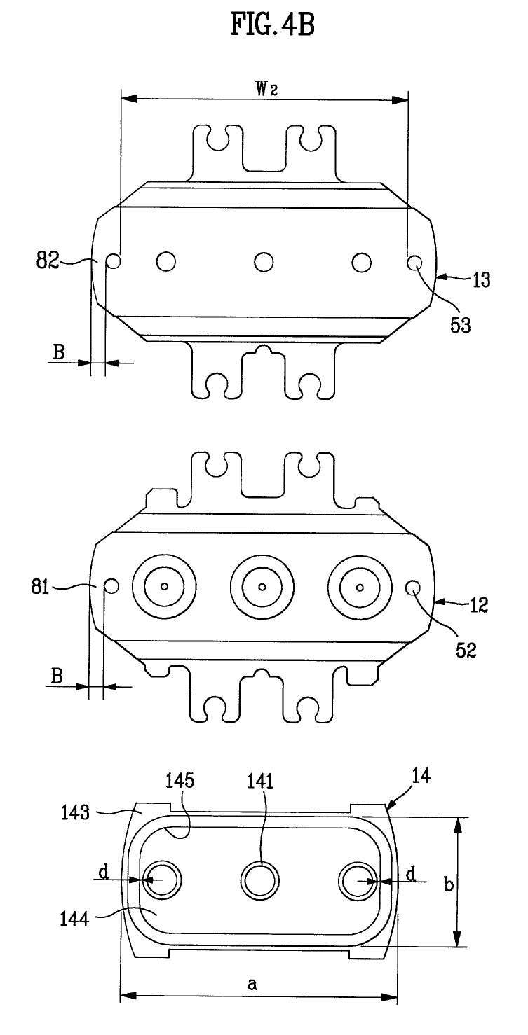

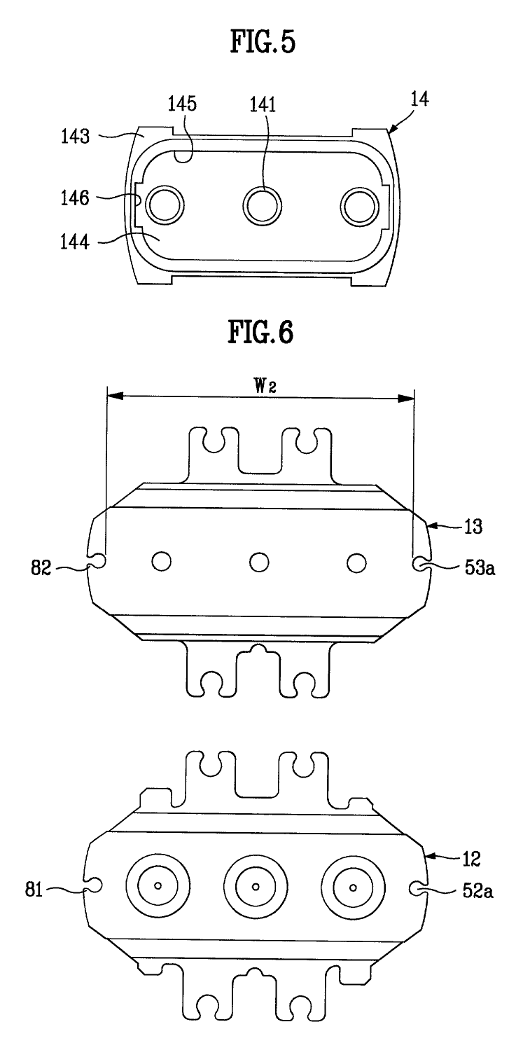

Initially, a first preferred embodiment of the present invention will be explained with reference to FIGS. 4a through 6. FIG. 4a is an exemplary view showing a state where guide pins of a beading jig are inserted through guide holes of a triple-electrode part and a pre-focusing electrode, and FIG. 4b is a front view of each electrode at the triple-electrode part of the electric gun of FIG. 4a.

Referring to FIGS. 4a and 4b, an electric gun for a color CRT(Cathode Ray Tube) according to the first preferred embodiment basically includes three electrodes 11 for radiating electron beams, a plurality of electrodes 12, 13, 21, 22, 23, 24, 30 and 40 for controlling, accelerating and focusing the electron beams, and guide holes 52, 53 and 54, through which guide means, namely, guide pins 62 of a beading jig are inserted, being formed at both side parts of some electrodes of the plurality of electrodes, such as, the control electrode 12, the first accelerating electrode 13 and the pre-focusing electrode 30.

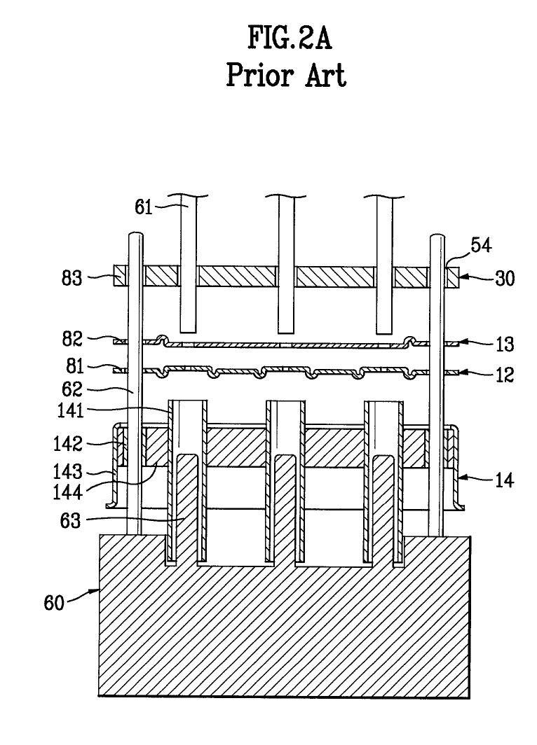

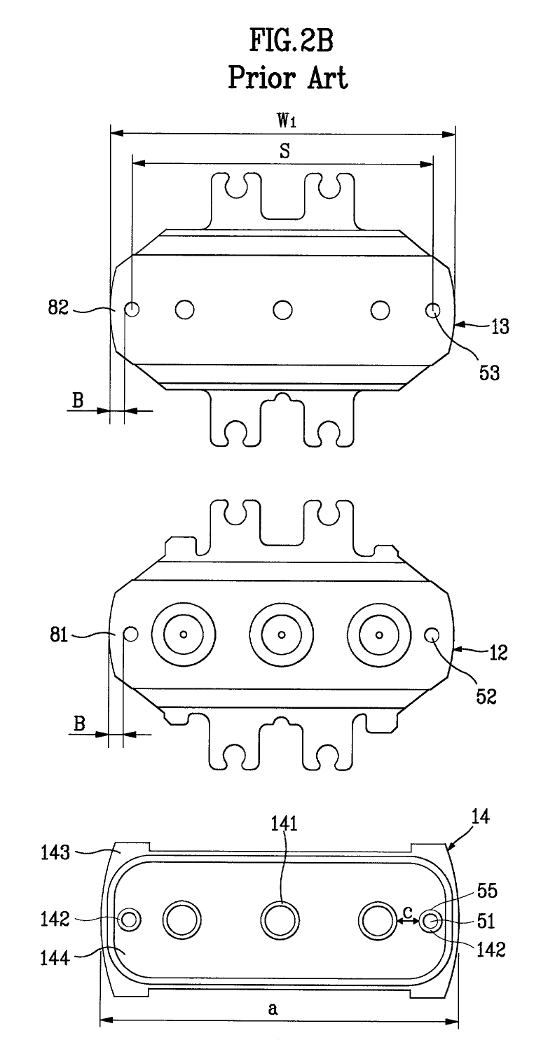

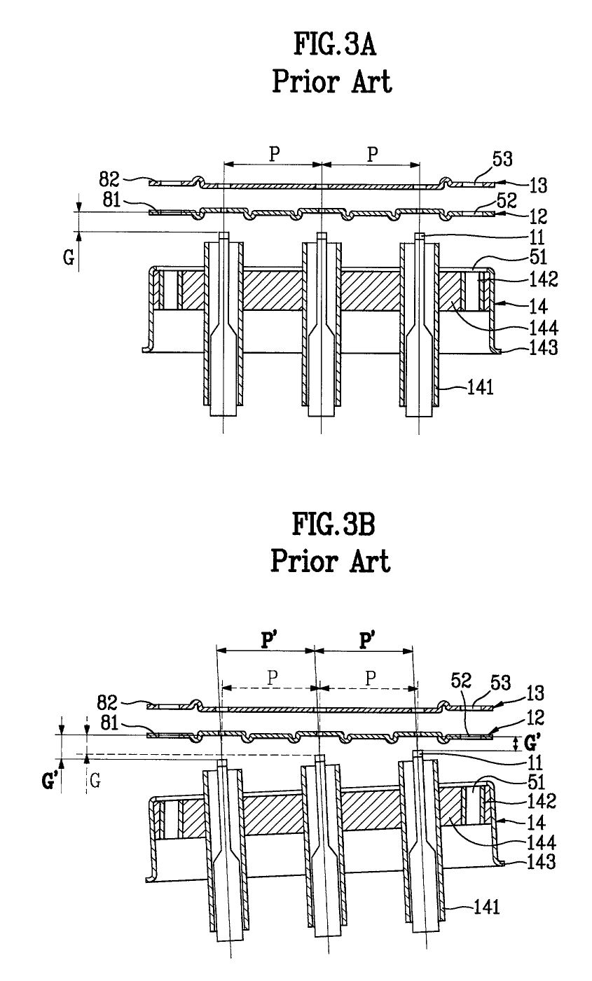

According to the present invention, a cathode supporter 14 supporting the cathodes 11 is comprised of cathode support tubes 141 for supporting the three cathodes R, G and B, a hermetic cap 143 for enclosing the cathode support tubes 141, and a ceramics glass 144 filled between the cathode support tubes 141 and an inner surface of the hermetic cap 143. The cathode supporter 14 according to the present invention is constructed not to have guide pipes 142 in an attempt to overcome the aforesaid problem generated due to the guide pipes 142 (see FIGS. 2a, 2b and 3) installed on the conventional cathode supporter 14. Even if the guide pipes 142 are removed from components of the cathode supporter 14, any particular problem would not arise in fixing the cathode supporter 14 since guides 63 extending from an arm part 60 of the beading jig are inserted into the cathode support tubes 141 to support the cathode supporter 14.

Through removal of the guide pipes 142, a horizontal length of the cathode supporter 14 occupied by the guide pipes 142, namely a horizontal length a of the hermetic cap 143 is possibly reduced. In the reduction of the horizontal length a of the cathode supporter 14, the horizontal length a of the hermetic cap 143 should be narrower than an inside horizontal length W₂ between guide holes 52, 53 and 54 formed on the control electrode 12, the first accelerating electrode 13 and the pre-focusing electrode 30, so that the guides extending from the arm part 60 of the beading jig may be not contacted with the hermetic cap 143.

The inside horizontal length W₂ between the guide holes 52, 53 and 54 is dependant on a thickness of a diameter of a neck part, a width B of bridges 81, 82 and 83 defining an outer side of the guide holes 52, 53 and 54 of the control electrode 12, the accelerating electrode 13 and the pre-focusing electrode 30, and a diameter of the guide holes 52, 53 and 54. The diameter of the guide holes 52, 53 and 54 are dependant on a diameter of the guide pins 62 which are inserted into the guide holes. The diameter of the guide pins 62 is generally 1.5 mm appropriate to support the control electrode 12, the accelerating electrode 13 and the pre-focusing electrode 30. However, even if the guide pins 62 having a diameter of 1 mm are applied to the beading jig, there does not occur any problem in supporting the electrodes 12, 13, and 30. Therefore, in the event that the guide pins 62 having a diameter of 1 mm are used in the control electrode 12, the first accelerating electrode 13 and the pre-focusing electrode 30, the guide holes 52, 53 and 54 are formed to have a diameter of approximately 1 mm so as to correspond to the diameter of the guide pins 62, while in the event that the guide pins 62 having a diameter of 1.5 mm are used in the electrodes 12, 13 and 30, the guide holes 52, 53 and 54 are formed to have a diameter of approximately 1.5 mm so as to correspond to the diameter of the guide pins 62. In the meantime, the minimum width B of the bridges 81, 82 and 83 is preferably maintained to a level of approximately 1 mm in consideration of processability.

As previously described, when the control electrode 12, the accelerating electrode 13 and the pre-focusing electrode 30, which are installed within the neck part of 29.1 mm in diameter and 2 mm in thickness, have a horizontal length W₁ of 22.1 mm or approximately 75% of the diameter of the neck part, if the guide holes 52, 53 and 54 of 1.0 mm are applied to the electrodes 12, 13 and 30, the horizontal length a of the hermetic cap 143 gets to be less than 18.1 mm or 62% of the neck part because of the width B of the bridges 81, 82 and 83. On the other hand, if the guide holes 52, 53 and 54 of 1.5 mm are applied, the horizontal length a of the hermetic cap 143 gets to be less than 17.1 mm or 59% of the diameter of the neck part. In further detail, when a tolerance of ±0.05 mm is permitted between the hermetic cap 143 and the guide pins 62, if the guide holes 52, 53 and 54 of 1.0 mm in diameter are used, the horizontal length a of the hermetic cap 143 gets to be less than 18.0 mm, or about 62% of the diameter of the neck part, whereas if the guide holes 52, 53 and 54 of 1.5 mm in diameter are used, the horizontal length a of the hermetic cap 143 gets to be less than 17.0 mm, or about 58% of the diameter of the neck part.

Meanwhile, as shown in FIG. 4b, a rim part 145 is formed in a nearly perpendicular direction to an advance direction of the electron beams along an inside of one end of the hermetic cap 143, which is disposed in a direction of a screen. As likely as the first preferred embodiment of the present invention, if the horizontal length W₁ of the hermetic cap 143 is reduced, a distance d between the rim part 145 and the cathode support tubes 141 supporting the R and B cathodes becomes narrower in some models of electric gun. Thus, there occurs a leakage current between the R and B cathode support tubes 141 and the rim part 145. In order to prevent the leakage current, the present invention makes wider the distance d between the hermetic cap 143 and the R and B cathode support tubes 141 through the following ways.

First, the distance between the rim part 145 of the electrodes of the hermetic cap 143 and the cathode support tubes 141 is increasable by forming a cut part 146 at the rim part adjacent to the R and B cathode support tubes 141.

Second, the distance between the rim part 145 and the R and B cathode support tubes 141 is increasable by enabling the horizontal length a of the hermetic cap 143 to be larger than that in the first embodiment of the present invention. However, if the horizontal length of the hermetic cap 143 is increased, an outer side of the hermetic cap 143 would be interfered with the guide pins 62 during a beading process. A pitch S should be raised by moving the control electrode 12, the accelerating electrode 13 and the pre-focusing electrode 30 to the outer side in order to prevent the interference. However, in this case, the width B of the bridges 81, 82 and 83 may be reduced to an extent of less than 1 mm. As a result, it is difficult to form the bridges 81, 82 and 83 and it is possible to cause an error at the pitch S of the guide holes 52, 53 and 54.

FIG. 6 is a front view of the control electrode 12 and the first accelerating electrode 13 on which excess semicircles 52a and 53a slightly larger than semicircles of the guide holes 52 and 53 are formed. The excess semicircles 52a and 53a are formed by removing some parts of the bridges 81 and 82 defining the outer side of the guide holes 52 and 53, superposing a horizontal outermost portion of the control electrode 12 and the first accelerating electrode 13 on an extension line of the outer side of the guide holes, and being semicircular shaped for the guide pins 62 not to vertically move. Consequently, if the excess semicircles 52a, 53a and 54a being opened at one outer side thereof are applied to the control electrode 12, the first accelerating electrode 13 and the pre-focusing electrode 30, the inside width W₂ between the semicircles can be increased by 1 mm relative to the prior art. In detail, the horizontal length a of the cathode supporter 14 can be 19.1 mm corresponding to 66% of the diameter of the neck part in case of the guide pins 61 of 1.0 mm in diameter, whereas the horizontal length a of the cathode supporter 14 can be 18.1 mm corresponding to 62% of the diameter of the neck part in case of the guide pins 62 of 1.5 mm in diameter.

The second preferred embodiment of the present invention applied to a manual assembling of the electric gun will be explained as herein below. The second preferred embodiment is similar to the first preferred embodiment of the present invention, with the exception that the former has no guide holes 52, 53 and 54 or 52a, 53a and 54a, through which the guide pins 62 are inserted into the control electrode 12, the first accelerating electrode 13 and the pre-focusing electrode 30 in the first preferred embodiment. Hence, figures concerning the second preferred embodiment are not specially attached hereto.

According to the second preferred embodiment of the present invention, the horizontal length a of the cathode supporter 14 is set to be smaller than the horizontal length W₁ of the control electrode 12, the first accelerating electrode 13 and the pre-focusing electrode 30 among the plurality of electrodes 12, 13, 21, 22, 23, 24, 30 and 40 for controlling, accelerating and focusing the electron beams. The maximum horizontal length a of the cathode supporter 14 in the above range is set to be less than 69%, which is smaller than the horizontal length of the cathode supporter 14, that is, the horizontal length a of the hermetic cap in the conventional manual assembling. In case that the horizontal length of the hermetic cap 143 is decreased in order to reduce the amount of the ceramics glass 144 used, there should also reduce the distance between the central axes of the three electron beam through holes of the control electrode 12, the first accelerating electrode 13 and the pre-focusing electrode 30. This both reduction is achieved by minimizing the distance between the central axes of the electron beam through holes with a precondition of not causing any problem in reproducing a picture color. In case of the electric gun applied to the neck part of 29.1 mm in diameter, the distance between the centers of the three electron beam through holes ranges from 5.08 to 6.60 mm. If there is used the distance of 5.08 mm, the least popular size, the minimum horizontal length a of the hermetic cap may be reduced to 16 mm, or about 55% of the diameter of the neck part. Therefore, the horizontal length a of the hermetic cap 143 according to the second preferred embodiment is within a range from the minimum 55% to the maximum 69%. The ratio a/b of the horizontal length a to the height b of the hermetic cap 143 is accordingly within a range from 1.66 to 2.08.

Since the minimum width of the hermetic cap 143 in accordance with the second preferred embodiment is identically applied in the first preferred embodiment, the hermetic cap 143 in accordance with the first preferred embodiment is within a range from the minimum 55% to the maximum 66%. The ratio a/b of the horizontal length a to the height b of the hermetic cap 143 is expressed within a range of 1.99 to 1.66.

The present invention has the following advantages by removing the guide pipes, which are used in the conventional art.

First, the present invention has an advantage of improving efficiency in the assembling of the cathode supporter with the control electrode and ensuring the precision type electric gun by eliminating a possibility of deformation of the guide pipes.

Second, the present invention has another advantage of preventing the leakage current from being created between the cathode support tubes and the guide pipes.

Third, the present invention has yet another advantage of reducing the manufacturing cost by removing the guide pipe manufacturing process and decreasing the horizontal length of the cathode supporter, that is, the horizontal length of the hermetic cap, thereby reducing the amount of the expensive ceramics glass used.

What is claimed is:

1. A cathode supporter for an electric gun embedded in a CRT(Cathode Ray Tube), the electric gun comprising:
three cathodes for radiating electron beams;
a plurality of electrodes for controlling, accelerating and focusing the electron beams; and
guide holes formed at both sides of some electrodes of the plurality of electrodes for allowing guide means to be inserted therethrough,
wherein a horizontal length of the cathode supporter supporting the cathodes is smaller than an inside horizontal length of the guide means to prevent any interference from being generated between the cathode supporter and the guide means.

2. The cathode supporter of claim 1, wherein the horizontal length of the cathode supporter is within a range of 55% to 66% of a diameter of a neck part.

3. The cathode supporter of claim 2, wherein a tolerance of 0.05 mm is permitted between the guide means and the cathode supporter.

4. The cathode supporter of claim 2 or 3, wherein the guide holes are of an excess semicircular shape with an outer side part thereof being opened.

5. The cathode supporter of claim 4, wherein the guide means are formed on a control electrode, an accelerating electrode, and a pre-focusing electrode among the plurality of electrodes, and are guide pins formed on a beading jig.

6. A cathode supporter for an electric gun embedded in a CRT(Cathode Ray Tube), the electric gun comprising:
three cathodes for radiating electron beams; and
a plurality of electrodes for controlling, accelerating and focusing the electron beams,
wherein a horizontal length of the cathode supporter supporting the cathodes is smaller than a horizontal length of a control electrode, an accelerating electrode, and a pre-focusing electrode of the plurality of cathodes.

7. The cathode supporter of claim 6, wherein the horizontal length of the cathode supporter is within a range of 55% to 69% of a diameter of a neck part.

8. The cathode supporter of either one among claims 1, 3, 5, and 7, wherein the cathode supporter includes cathode support tubes for supporting the cathodes, respectively, a hermetic cap for enclosing the cathode support tubes, a ceramics glass filled between the cathode support tubes and an inner surface of the hermetic cap, and a rim part being formed in a nearly perpendicular direction to an advance direction of the electron beams along an inside of one end of the hermetic cap, which is positioned in a direction of a screen.

9. The cathode supporter of claim 8, wherein a cut part is formed on the rim part at a portion being closest to the two cathode support tubes, which are positioned at an outer side.

10. The cathode supporter of claim 9, wherein a ratio a/b of a horizontal length a to a height b of the cathode supporter is within a range of 166 to 2.08, in case of a manual assembling of the electric gun.

11. The cathode supporter of claim 9, wherein a ratio a/b of a horizontal length a to a height b of the cathode supporter is within a range of 1.66 to 1.99, in case of an automated assembling of the electric gun.

12. The cathode supporter of claim 11, wherein it is desirable that the ratio a/b of the horizontal length a to the height b of the cathode supporter is 1.78.
